(19) United States
(12) Patent Application Publication
(10) Pub. No.: US 2013/0317653 A1
(43) Pub. Date: Nov. 28, 2013

(54) ELECTRONIC CAM CONTROL DEVICE AND ELECTRONIC CAM CURVE GENERATING METHOD

(71) Applicants: Koichiro Ueda, Chiyoda-ku (JP); Yoshihiro Marushita, Chiyoda-ku (JP); Kimihiro Mizuno, Chiyoda-ku (JP)

(72) Inventors: Koichiro Ueda, Chiyoda-ku (JP); Yoshihiro Marushita, Chiyoda-ku (JP); Kimihiro Mizuno, Chiyoda-ku (JP)

(73) Assignee: MITSUBISHI ELECTRIC CORPORATION, Chiyoda-ku, Tokyo (JP)

(21) Appl. No.: 13/820,774

(22) PCT Filed: May 24, 2012
(86) PCT No.: PCT/JP12/63366

§ 371 Date: Mar. 5, 2013

(51) Int. Cl. G05B 11/36; F16H 25/08

(52) U.S. Cl. CPC G05B 11/36; F16H 25/08
USPC 700/275

(57) ABSTRACT

An electronic cam control device includes an electronic-cam-curve generating unit configured to generate an electronic cam curve to pass a plurality of designated coordinates that define a relation between a main shaft position and a driven shaft position and an output unit configured to output the driven shaft position corresponding to the main shaft position. The electronic-cam-curve generating unit generates the electronic cam curve to include a section where a waveform of cam velocity obtained by differentiating the electronic cam curve with respect to the main shaft position changes to fixed cam velocity in each of regions, which are regions among the designated coordinates, and include a monotonous acceleration or deceleration section that connects sections where the waveform of the cam velocity changes to the fixed cam velocity by accelerating or decelerating while monotonously increasing or monotonously decreasing between adjacent regions.

### FIELD

The present invention relates to an electronic cam control device and an electronic cam curve generating method for generating, as an electronic cam curve, a relation between the position of a main shaft and a position where a driven shaft should operate according to the position of the main shaft.

### BACKGROUND

An electronic cam control device is a device not mounted with a mechanical cam mechanism and configured to output, based on an electronic cam curve set by software, a position where a driven shaft should operate according to the position of a main shaft. The position of the main shaft is, for example, the position of a servomotor of another shaft or the position of a synchronization encoder provided in a certain rotating shaft.

For example, the electronic cam device is used for a rotary cutter apparatus that drives, while continuously sending web-like paper or film, a rotary cutter in synchronization with a flow of the paper or the film and cuts the paper or the film for each fixed dimension. When the electronic cam control device is applied to the rotary cutter apparatus, the main shaft is the position of a motor for sending the paper or the film and the driven shaft is in a rotating position of the rotary cutter.

Such an electronic cam control device generates, based on a plurality of coordinate data that define a relation between a plurality of main shaft positions and a plurality of driven shaft positions, an electronic cam curve for outputting a driven shaft position corresponding to a main shaft position. A command for a position to which the driven shaft should move is calculated such that the electronic cam curve passes a designated plurality of coordinate data and, when the main shaft position is present between coordinate data, by interpolating the coordinate data using a predetermined method. A method of generating the electronic cam curve by interpolating designated coordinates with straight lines has been used. This method has an advantage that it is possible to intuitively grasp, by approximating the designated coordinates with the straight lines, the behavior between the coordinates of the electronic cam curve. In other words, even when the main shaft position is present between the coordinates, it is possible to grasp, with the electronic cam curve, how the driven shaft position is controlled.

However, when the control is performed using the electronic cam curve obtained by connecting the coordinates using the straight lines, cam velocity obtained by differentiating the position of the electronic cam curve with the driven shaft position takes a fixed value for each of regions among designated coordinates. Therefore, when the main shaft operates at certain velocity, the velocity suddenly changes when the main shaft passes a designated coordinate. As a result, an extremely large shock or vibration occurs in a machine driven by a driven shaft motor. To prevent such occurrence of a shock or a vibration, an electronic cam device disclosed in Patent Literature 1 generates a cam curve for setting acceleration in designated coordinates to 0.

### CITATION LIST

### Patent Literature

Patent Literature 1: Japanese Patent Application Laid-Open No. 2002-132854

### SUMMARY

### Technical Problem

However, in the related art, because the cam curve is generated to set acceleration to 0 at a designated coordinate point, large acceleration occurs depending on a section. In particular, when the main shaft passes a first section or a last section, the driven shaft position moves to decelerate toward the next coordinate point after accelerating. Therefore, there is a problem in that the acceleration of the driven shaft tends to be large.

When maximum torque of a driven shaft servomotor is small or when the inertia of a mechanical load connected to the driven shaft servomotor is large, if the driven shaft servomotor is controlled at large acceleration according to a cam curve, the driven shaft servomotor operates exceeding the maximum torque of the driven shaft servomotor. In such a case, a problem occurs in that the position of the driven shaft servomotor cannot sufficiently follow a position commanded by an electronic cam curve or a problem occurs in that a vibration or a shock occurs in the driven shaft.

The present invention has been devised in view of the above and it is an object of the present invention to obtain an electronic cam control device and an electronic cam curve generating method that that makes it possible to generate an electronic cam curve that passes a designated coordinate and with which the acceleration of a driven shaft during driving is suppressed.

### Solution to Problem

There is provided an electronic cam control device comprising: an input unit configured to receive an input of a plurality of designated coordinates that define a relation between a main shaft position and a driven shaft position; an electronic-cam-curve generating unit configured to generate an electronic cam curve to pass the plurality of designated coordinates, the electronic cam curve representing, as a curve, a relation between the main shaft position and the driven shaft position; and an output unit configured to output the driven shaft position corresponding to the main shaft position as a driven shaft position command to an external device, the driven shaft position command confirming to the electronic cam curve, wherein the electronic-cam-curve generating unit generates the electronic cam curve to include a section where a waveform of cam velocity obtained by differentiating the electronic cam curve with respect to the main shaft position changes to fixed cam velocity in each of regions, which are regions among the designated coordinates, and include a monotonous acceleration or deceleration section that connects sections where the waveform of the cam velocity changes to the fixed cam velocity by accelerating or decelerating while monotonously increasing or monotonously decreasing between adjacent regions.

### Advantageous Effects of Invention

With the electronic cam control device and the electronic cam curve generating method according to the present invention, there is an effect that it is possible to generate an electronic cam curve that passes a designated coordinate and with which the acceleration of a driven shaft during driving is suppressed.

### BRIEF DESCRIPTION OF DRAWINGS

FIG. 1 is a diagram of the configuration of an electronic cam system according to a first embodiment.

FIG. 2 is a diagram of the configuration of an electronic cam control device.

FIG. 3 is a flowchart for explaining a procedure of processing for generating for an electronic cam curve according to the first embodiment.

FIG. 4 is a diagram of an electronic cam curve according to the first embodiment.

FIG. 5 is a diagram for explaining a relation between a main shaft position and cam velocity.

FIG. 6 is a diagram for explaining conditions that need to be satisfied between an amount of movement of a main shaft and an amount of movement of a driven shaft.

FIG. 7 is a diagram of the configuration of an electronic cam system according to a second embodiment.

FIG. 8 is a flowchart for explaining a procedure of processing for generating for an electronic cam curve according to the second embodiment.

FIG. 9 is a diagram of the configuration of an electronic cam system according to a third embodiment.

FIG. 10 is a flowchart for explaining a procedure of processing for generating for an electronic cam curve according to the third embodiment.

FIG. 11 is a diagram of an electronic cam curve according to the third embodiment.

FIG. 12 is a flowchart for explaining a procedure of processing for generating for an electronic curve according to a fourth embodiment.

FIG. 13 is a diagram of an electronic cam curve according to the fourth embodiment.

### DESCRIPTION OF EMBODIMENTS

Electronic cam control devices and electronic cam generating methods according to embodiments of the present invention are explained in detail below based on the drawings. The invention is not limited by the embodiments.

### First Embodiment

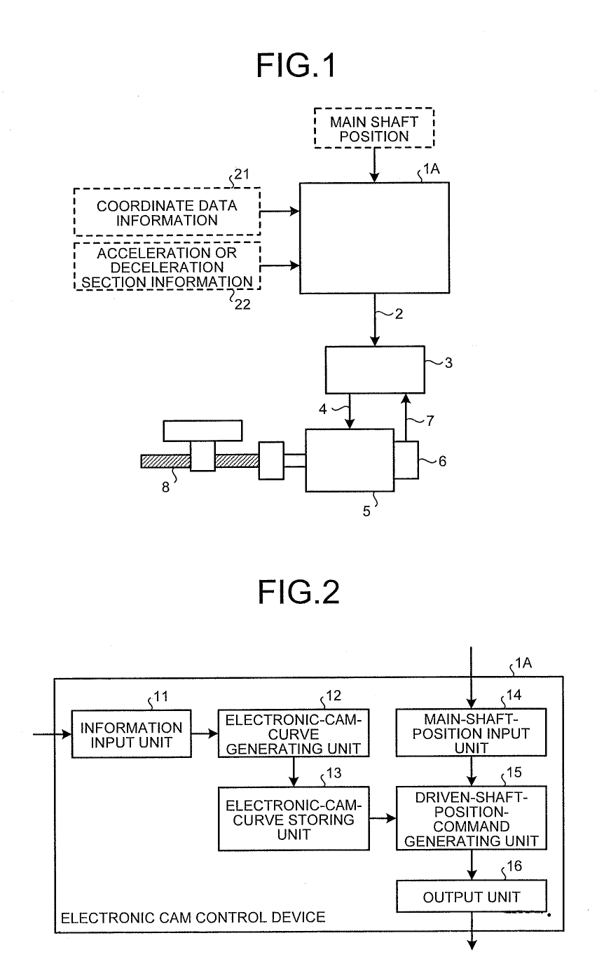

FIG. 1 is a diagram of the configuration of an electronic cam system according to a first embodiment. The electronic cam system includes an electronic cam control device 1A, a servo amplifier 3, a servomotor 5, an encoder 6, and a load machine 8.

The electronic cam control device 1A is a device that generates an electronic cam curve and controls the servo amplifier 3, the servomotor 5, and the load machine 8 using the generated electronic cam curve. In the electronic cam system, the electronic cam control device 1A controls the servo amplifier 3, whereby the servo amplifier 3 controls the servomotor 5. Consequently, the load machine 8 is controlled.

The electronic cam control device 1A generates the electronic cam curve based on coordinate data information 21 and acceleration or deceleration section information 22, which are input by a user in advance, for defining a positional relation between a main shaft position and a driven shaft position.

The coordinate data information 21 is information including N (N is a natural number) coordinate data (designated coordinates). The acceleration or deceleration section information 22 is information including (N+1) acceleration or deceleration sections (section length data). The acceleration or deceleration sections are information indicating the lengths of sections where cam velocity is changed. In the following explanation, the N coordinate data defining a positional relation between a main shaft position and a driven shaft position are represented as coordinate data (X₁, Y₂), (X₂, Y₂), . . . , and (X_{N}, Y_{N}). It is assumed that, when the main shaft position is Xᵢ (i is a natural number of 1 to N), the driven shaft position passes Yᵢ. The (N+1) acceleration or deceleration sections are represented as acceleration or deceleration sections t₀, t₁, . . . , and t_{N}.

The electronic cam curve is a function or a table for associating the main shaft position with the driven shaft position in a one-to-one relation. The electronic cam control device 1A outputs the driven shaft position corresponding to the main shaft position as a driven shaft position command 2 according to the electronic cam curve (a waveform corresponding to the function or the table). The main shaft position is, for example, the position of an encoder attached to a servomotor other than the servomotor 5 or a position of an encoder attached to a machine.

The electronic cam control device 1A calculates the driven shaft position from the main shaft position using the generated electronic cam curve and generates the driven shaft position command 2 using the derived driven shaft position. The electronic cam control device 1A is connected to the servo amplifier 3 to output the driven shaft position command 2 to the servo amplifier 3.

The servo amplifier 3 is connected to the servomotor 5 that functions as a driven shaft. The encoder 6 is attached to the servomotor 5. The servo amplifier 3 outputs an electric current 4 for controlling the servomotor 5, which functions as the driven shaft, to the servomotor 5 based on the driven shaft position command 2 output by the electronic cam control device 1A. Specifically, the servo amplifier 3 outputs the electric current 4 by performing feedback control to cause a position 7 of the servomotor 5 output by the encoder 6 to follow the driven shaft position command 2. The load machine 8 is connected to the servomotor 5, which functions as the driven shaft, and driven by the servomotor 5.

FIG. 2 is a diagram of the configuration of the electronic cam control device. The electronic cam control device 1A includes an information input unit 11, an electronic-cam-curve generating unit 12, an electronic-cam-curve storing unit 13, a main-shaft-position input unit 14, a driven-shaft-position-command generating unit 15, and an output unit 16.

The information input unit 11 receives an input of the coordinate data information 21 and the acceleration or deceleration section information 22 and sends the information to the electronic-cam-curve generating unit 12. The electronic-cam-curve generating unit 12 generates an electronic cam curve using the coordinate data information 21 and the acceleration or deceleration section information 22.

The electronic-cam-curve storing unit 13 is a memory or the like that stores the electronic cam curve generated by the electronic-cam-curve generating unit 12. The main-shaft-position input unit 14 receives an input of a main shaft position sent from an external device (an encoder, etc.) and sends the main shaft position to the driven-shaft-position-command generating unit 15. The driven-shaft-position-command generating unit 15 generates, based on the electronic cam curve, the driven shaft position command 2 from the main shaft position. The output unit 16 outputs the driven shaft position command 2 generated by the driven-shaft-position-command generating unit 15 to the servo amplifier 3.

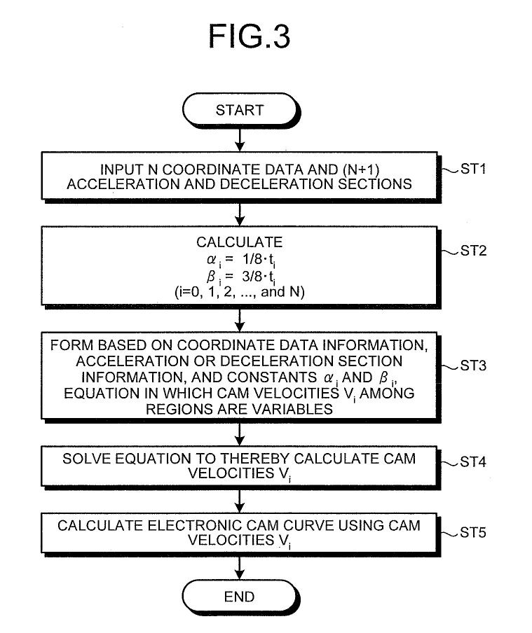

FIG. 3 is a flowchart for explaining a procedure of processing for generating an electronic cam curve according to the first embodiment. The coordinate data information 21 and the acceleration or deceleration section information 22 are input to the information input unit 11 of the electronic cam control device 1A.

The coordinate data information 21 is information concerning a plurality of designated coordinates for defining a relation between a main shaft position and a driven shaft position. Specifically, the coordinate data information 21 is N coordinate data (X₁, Y₁), (X₂, Y₂), . . . , and (X_{N}, Y_{N}) for defining positions Yᵢ where the driven shaft should pass when the main shaft passes positions Xᵢ. It is assumed that there is a relation X₁<X₂<X₃< . . . <X_{N} among the main shaft positions X₁ to X_{N}. Reference coordinate data is represented as coordinate data (X₀, Y₀)=(0, 0).

The acceleration or deceleration section information 22 is information representing section length required until cam velocity obtained by differentiating the position of the electronic cam curve with the driven shaft position reaches fixed velocity and is (N+1) acceleration or deceleration sections t₀, t₁, . . . , and t_{N}. It is assumed that there are limitations explained below (Formulas (1) to (3)) concerning acceleration or deceleration sections tᵢ. In this way, the N coordinate data and the (N+1) acceleration or deceleration sections are input to the information input unit 11 of the electronic cam control device 1A (step ST1).

t₀+t₁/2≦X₁ (1)

t₂/2+tᵢ₋₁/2≦Xᵢ−Xᵢ₋₁ (2)

t_{N-1}/2+t_{N}≦X_{N}−X_{N-1} (3)

The information input unit 11 inputs the coordinate data information 21 and the acceleration or deceleration section information 22 to the electronic-cam-curve generating unit 12. The electronic-cam-curve generating unit 12 calculates constants αᵢ and ⊖ᵢ defined using the coordinate data information 21 and the acceleration or deceleration section information 22 (step ST2). The constants αᵢ and βᵢ are represented by Formulas (4) and (5) below. In Formulas (4) and (5), 0≦i≦N.

αᵢ=⅛·tᵢ (4)

βᵢ=⅜·tᵢ (5)

The electronic-cam-curve generating unit 12 forms, based on the coordinate data information 21, the acceleration or deceleration section information 22, and the calculated constants αᵢ and βᵢ, Formula (6) below as simultaneous linear equations with N unknown variables in which variables are cam velocities Vᵢ (i=1, 2, . . . , and N) of coordinate sections (step ST3).

$$( \begin{matrix}C ( 1 , 1 ) & C ( 1 , 2 ) & 0 & & & … & & 0 \\ C ( 2 , 1 ) & C ( 2 , 2 ) & C ( 2 , 3 ) & 0 & & & & \\ 0 & C ( 3 , 2 ) & C ( 3 , 3 ) & C ( 3 , 4 ) & 0 & & & ⋮ \\ & 0 & C ( 4 , 3 ) & C ( 4 , 4 ) & & & & \\ & & 0 & & … & & 0 & \\ ⋮ & & & & & C ( \begin{matrix}N - 2 , \\ N - 2\end{matrix} ) & C ( \begin{matrix}N - 2 , \\ N - 1\end{matrix} ) & 0 \\ & & & & 0 & C ( \begin{matrix}N - 1 , \\ N - 2\end{matrix} ) & C ( \begin{matrix}N - 1 , \\ N - 1\end{matrix} ) & C ( N - 1 , N ) \\ 0 & & … & & & 0 & C ( N - 1 , N ) & C ( N , N )\end{matrix} ) ( \begin{matrix}{V}_{1} \\ {V}_{2} \\ {V}_{3} \\ \\ ⋮ \\ \\ \\ {V}_{N}\end{matrix} ) = ( \begin{matrix}{Y}_{1} \\ {Y}_{2} - {Y}_{1} \\ {Y}_{3} - {Y}_{2} \\ \\ ⋮ \\ \\ \\ {Y}_{N} - {Y}_{N - 1}\end{matrix} ) \qquad ( 6 )$$

A coefficient matrix in the formula is a tridiagonal matrix. Coefficients of the coefficient matrix are defined as shown below from coordinate data information, acceleration or deceleration sections, and the calculated constants αᵢ and βᵢ.

C(1,1)=X₁−t₀/2−α₁

C(1,2)=α₁

C(N,N−1)=−β_{N-1}+t_{N-1}/2

C(N,N)=β_{N-1}+X_{N}−X_{N-1}−(t_{N}+t_{N-1})/2

when 2N−1,

C(i,i−1)=−β_{α-1}+tᵢ₋₁/2

C(i,i)=βᵢ₋₁−αⱼ+Xᵢ−Xᵢ₋₁−tᵢ₋₁/2

C(i,i+1)=αᵢ

The electronic-cam-curve generating unit 12 solves the simultaneous linear equations with N unknown variables of Formula (6), in which the cam velocities Vᵢ (i=1, 2, . . . , and N) are unknown numbers, to thereby calculate the cam velocities Vᵢ (i=1, 2, . . . , and N) (step ST4). The electronic-cam-curve generating unit 12 calculates an electronic cam curve using the calculated cam velocities Vᵢ (step ST5). Specifically, the electronic-cam-curve generating unit 12 calculates, as the electronic cam curve, a driven shaft position Y(X) corresponding to a main shaft position (X) represented by Formulas (7-1) to (7-9) below. The electronic-cam-curve generating unit 12 causes the electronic-cam-curve storing unit 13 to store the calculated electronic cam curve.

$$\begin{matrix}0 \leq X \leq {t}_{0} \\ y ( X ) = \frac{{V}_{1}}{2 {t}_{0}} {X}_{2} & ( 7 \text{-} 1 ) \\ {t}_{0} < X < {X}_{1} - {t}_{1} / 2 \\ y ( X ) = {V}_{1} X - \frac{1}{2} {V}_{1} {t}_{0} & ( 7 \text{-} 2 ) \\ {X}_{1} - {t}_{1} / 2 \leq X \leq {X}_{1} \\ y ( X ) = \frac{{V}_{2} - {V}_{1}}{2 {t}_{1}} {\{ X - ( {X}_{1} - \frac{{t}_{1}}{2} ) \}}^{2} + {V}_{1} X - \frac{1}{2} {V}_{1} {t}_{0} & ( 7 \text{-} 3 )\end{matrix}$$

With respect to 2≦i≦N−1

$$\begin{matrix} 2 ≦ i ≦ N - 1 \\ {X}_{i - 1} \leq X \leq {X}_{i - 1} + {t}_{i - 1} / 2 \\ y ( X ) = {Y}_{i - 1} + \frac{{V}_{i} - {V}_{i - 1}}{2 {t}_{i - 1}} {( X - {X}_{i - 1} )}^{2} & ( 7 \text{-} 4 ) \\ {X}_{i - 1} + {t}_{i - 1} / 2 < X < {X}_{i} - {t}_{i} / 2 \\ y ( X ) = {Y}_{i - 1} + {β}_{i - 1} ( {V}_{i} - {V}_{i - 1} ) + {V}_{i - 1} {t}_{i - 1} / 2 + {V}_{i} ( \frac{X - {X}_{i - 1} - {t}_{i - 1}}{2} ) & ( 7 \text{-} 5 ) \\ {X}_{i} - {t}_{i} / 2 \leq X \leq {X}_{i} \\ y ( X ) = {Y}_{i - 1} + {β}_{i - 1} ( {V}_{i} - {V}_{i - 1} ) + {V}_{i - 1} {t}_{i - 1} / 2 + {V}_{i} ( \frac{X - {X}_{i - 1} - {t}_{i - 1}}{2} ) + \frac{{V}_{i + 1} - {V}_{i}}{2 {t}_{i}} {( \frac{X - {X}_{i} - {t}_{i}}{2} )}^{2} & ( 7 \text{-} 6 ) \\ {X}_{N - 1} \leq X \leq {X}_{N - 1} + {t}_{N - 1} / 2 \\ y ( X ) = {Y}_{N - 1} + \frac{{V}_{N} - {V}_{N - 1}}{2 {t}_{N - 1}} {( X - {X}_{N - 1} )}^{2} & ( 7 \text{-} 7 ) \\ {X}_{N - 1} + {t}_{N - 1} / 2 + 1 < X < {X}_{N} - {t}_{N} \\ y ( X ) = {Y}_{N - 1} + {β}_{N - 1} ( {V}_{N} - {V}_{N - 1} ) + {V}_{N - 1} {t}_{N - 1} / 2 + {V}_{N} ( \frac{X - {X}_{N - 1} - {t}_{N - 1}}{2} ) & ( 7 \text{-} 8 ) \\ {X}_{N} - {t}_{N} \leq X \leq {X}_{N} \\ y ( X ) = {Y}_{N - 1} + {β}_{N - 1} ( {V}_{N} - {V}_{N - 1} ) + {V}_{N - 1} {t}_{N - 1} / 2 + {V}_{N} ( \frac{{X}_{N} - {X}_{N - 1} - {t}_{N - 1}}{2 - {t}_{N}} ) - \frac{{V}_{N}}{2 {t}_{N}} {( X - {X}_{N} + {t}_{N} )}^{2} & ( 7 \text{-} 9 )\end{matrix}$$

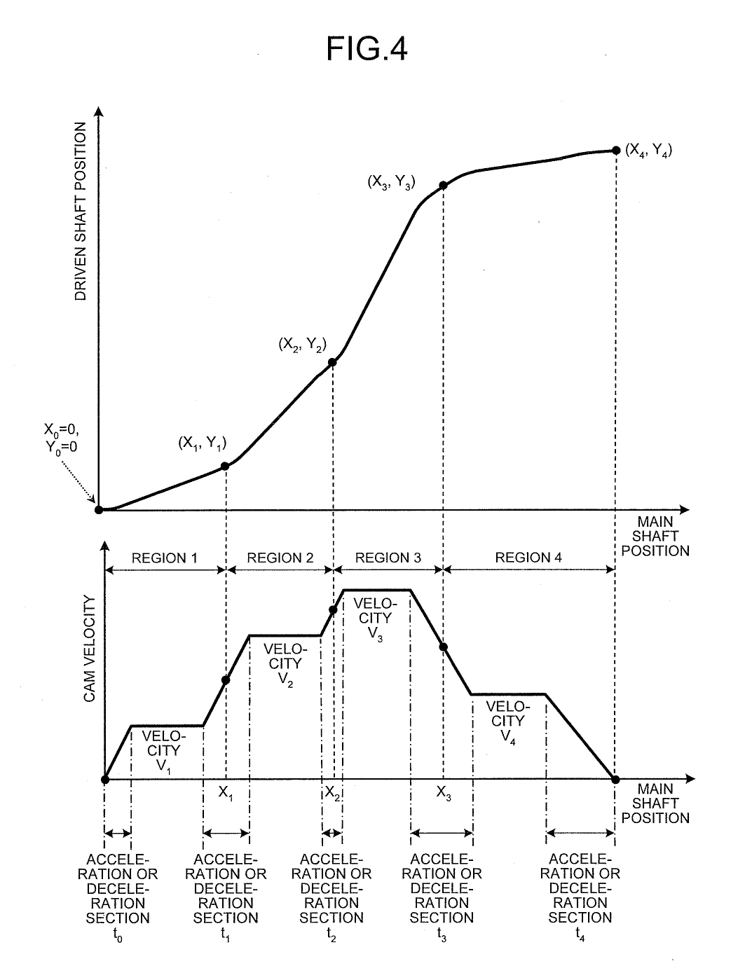

Effects of this embodiment are explained. FIG. 4 is a diagram of the electronic cam curve according to the first embodiment. In FIG. 4, a relation between the electronic cam curve (an upper waveform) generated according to the flowchart of FIG. 3 and a schematic shape of cam velocity (a lower waveform) obtained by differentiating the electronic cam curve with respect to the main shaft position is shown. In the following explanation, (X₁, Y₁) to (X₄, Y₄) are designated as coordinates of the main shaft position.

In a graph shown on the upper side of FIG. 4, the abscissa indicates the main shaft position and the ordinate indicates the driven shaft position. A waveform passing the coordinates (X₀, Y₀) to (X₄, Y₄) is the electronic cam curve. In a graph shown on the lower side of FIG. 4, the abscissa indicates the main shaft position and the ordinate indicates the cam velocity.

When the main shaft position increases at a fixed rate, the velocity of the servomotor 5 (the driven shaft) is a value proportional to the cam velocity. The servomotor 5 operates according to the waveform of the cam velocity. When the electronic cam curve according to this embodiment is formed, the cam velocity changes to fixed cam velocities Vᵢ for each of regions i, which are regions among designated coordinates. The cam velocity is accelerated or decelerated to cam velocities Vᵢ₊₁ and Vᵢ₋₁ adjacent to the cam velocities Vᵢ while monotonously increasing or monotonously decreasing. In this way, the cam velocity in this embodiment has the waveform formed by straight lines.

Consequently, coordinate sections assuming straight lines that linearly monotonously increase or monotonously decrease are acceleration or deceleration sections tᵢ (i=0, 1, . . . , and N) input to the information input unit 11. The designated coordinates pass coordinates right in middle points of the acceleration or deceleration sections. The limitations of Formulas (1) to (3) are applied to the acceleration or deceleration sections tᵢ to prevent the sections assuming the fixed cam velocities Vᵢ from having negative velocity. When the main shaft position is 0 and X_{N} (a first designated coordinate and a last designated coordinate), the cam velocity is 0 in the designated positions.

Effects explained below are obtained by using the electronic curve in which the waveform of the cam velocity is such a shape (pattern). Because the cam velocity is continuous, even when the main shaft operates at fixed velocity, the velocity of the driven shaft does not suddenly change at designated coordinate points. Therefore, a sudden velocity change does not occur in the servomotor 5, which is a driven shaft motor), either. There is an effect that, even if the driven shaft operates according to the electronic cam curve, a shock less easily occurs.

When the main shaft moves from a certain coordinate (Xᵢ, Yᵢ) to another coordinate (Xᵢ₊₁, Yᵢ₊₁) while operating at the fixed velocity, the driven shaft assumes the cam velocity Vᵢ for each of the regions i among the designated coordinates and moves such that the cam velocity Vᵢ changes to another cam velocity Vᵢ₊₁ while monotonously increasing or monotonously decreasing between the regions i. Therefore, a useless acceleration or deceleration action does not occur in the movement among the designated coordinates. As a result, there is an effect that it is possible to reduce the torque of the servomotor 5, which is the driven shaft motor, during driving.

In the electronic cam curve in the past, because only coordinate data is simply input, the electronic cam curve is uniquely determined. Therefore, depending on coordinate data and the velocity in the main shaft position, when the driven shaft is driven according to the electronic cam curve, the torque of the driven shaft sometimes exceeds the maximum torque. In this embodiment, the electronic-cam-curve generating unit 12 uses, besides the coordinate data, the acceleration or deceleration sections tᵢ in which the magnitude of the torque of the driven shaft can be changed. Therefore, the acceleration or deceleration of the servomotor 5 is changed to gentle motion by increasing the acceleration or deceleration sections tᵢ. Therefore, there is an effect that it is possible to prevent the torque of the servomotor 5, which is the driven shaft motor, from exceeding the maximum torque during driving.

There are a large number of methods of interpolating a plurality of coordinate data to form a curve. In the methods, it is guaranteed that the curve passes designated coordinates. However, when the main shaft position takes a value between the coordinate data, it is difficult to grasp what kind of a value the driven shaft position takes. According to this embodiment, the cam velocity has a characteristic that the cam velocity is formed by the fixed velocity and the straight lines on which the cam velocity monotonously increases (monotonous acceleration or deceleration sections). Therefore, the electronic cam curve assumes a waveform close to a curve obtained by connecting the coordinate data using the straight lines. Therefore, there is an effect that, even when the main shaft position is the position between the designated coordinates, it is easy to intuitively understand an output driven shaft position according to the electronic cam curve.

When the main shaft position is in a range of 0≦X≦X_{N}, the electronic cam curve is calculated using Formulas (7-1) to (7-9). However, with respect to the main shaft position in a range of X_{N}≦X≦2X_{N}, the driven shaft position is calculated according to values obtained by substituting X-X_{N} in X of Formulas (7-1) to (7-9). In other words, when the main shaft position X exceeds X_{N}, the electronic-cam-curve generating unit 12 applies Formula (7-1) to (7-9) using, as the main shaft position, the remainder left by dividing the main shaft position X by one cycle length X_{N} and calculates the driven shaft position.

Even when the electronic cam control device 1A performs the operation explained above (the operation in which the main shaft position exceeds the main shaft position X_{N} of the last coordinate), according to this embodiment, as shown in FIG. 4, the cam velocity is 0 when the main shaft position is 0 and X_{N}. When the main shaft position X moves from a value smaller than X_{N} to a value larger than X_{N} (when the main shaft position X takes values on both sides of X_{N}), the cam velocity is 0. Therefore, there is an effect that a large shock does not occur during driving in the servomotor 5 driven by the driven shaft.

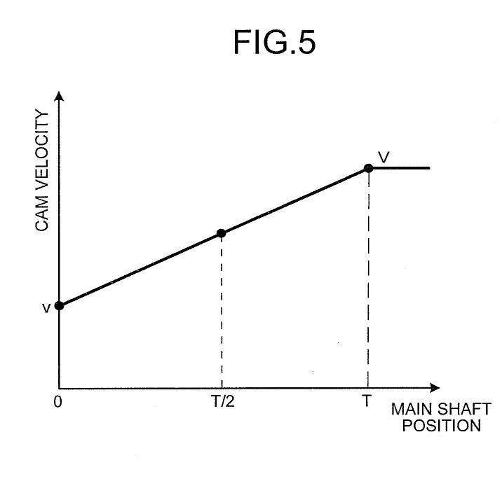

The electronic cam curve having the waveform of the cam velocity shown in FIG. 4 can be obtained by performing the calculation according to the flowchart of FIG. 3. A reason for this is explained below. FIG. 5 is a diagram for explaining a relation between the main shaft position and the cam velocity. In a graph shown in FIG. 5, the abscissa indicates the main shaft position and the ordinate indicates the cam velocity.

First, as shown in FIG. 5, the cam velocity in the main shaft position 0 is represented as v. The cam velocity of an electronic cam curve in which the cam velocity is in the main shaft position T is V and the cam velocity linearly changes is considered. In this case, u of the cam velocity can be represented by a linear expression with respect to the main shaft position X.

u={(V−v)·X/T}+v

The cam velocity is velocity obtained by differentiating a position command for the driven shaft with respect to the main shaft position. Therefore, the driven shaft position is obtained by integrating the cam velocity with respect to the main shaft position. Specifically, a driven shaft position y(X) can be represented by a formula below using the main shaft position X (0≦X≦T).

y(X)={(V−v)·X²/2T}+vX+D

where, D is the driven shaft position in the main shaft position 0.

An amount the driven shaft position moves while the main shaft position shifts from 0 to T/2 (an amount of movement A1) can be calculated by y(T/2)−y(0) as indicated by Formula (8) below. In Formula (8), α is α=(⅛)T.

A1=(V−v)·α+v·T/2 (8)

An amount the driven shaft position moves while the main shaft position moves from T/2 to T (an amount of movement A2) can be calculated by y(T)−y(T/2) as indicated by Formula (9) below. In Formula (9), β is β=(⅜)T.

A2=(V−v)·β+v·T/2 (9)

Further, an amount the driven shaft position moves while the main shaft position moves from 0 to T (an amount of movement A3) can be calculated by α+β as indicated by Formula (10) below.

$$A 3 = \frac{V - v}{2} \cdot T + v \cdot T \qquad ( 10 )$$

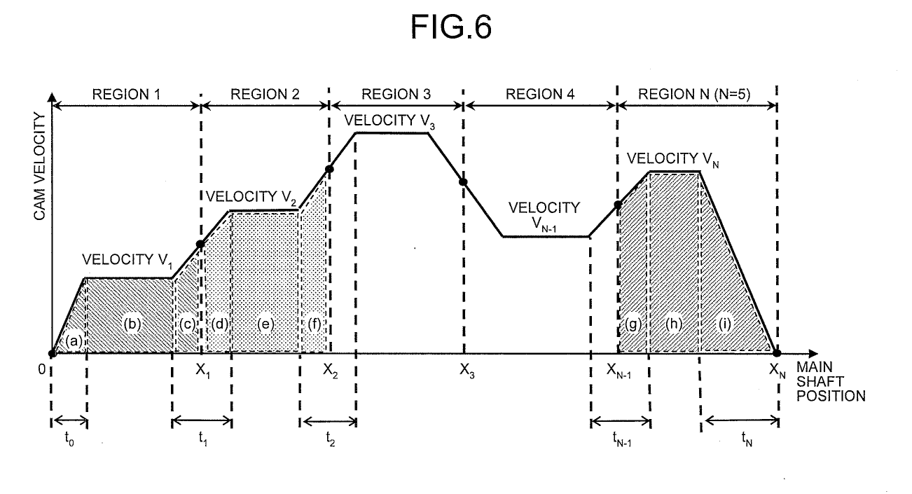

Conditions that need to be satisfied between an amount of movement of the main shaft and an amount of movement of the driven shaft to obtain the electronic cam curve according to this embodiment are explained. FIG. 6 is a diagram for explaining the conditions that need to be satisfied between the amount of movement of the main shaft and the amount of movement of the driven shaft. In a graph shown in FIG. 6, the abscissa indicates the main shaft position and the ordinate indicates the cam velocity.

The cam velocity in this embodiment is formed by fixed cam velocities V₁, . . . , and V_{N} (N=5) and monotonous acceleration or deceleration that linearly accelerates or decelerates while monotonously increasing or monotonously decreasing with respect to fixed cam velocities of adjacent regions. In other words, the electronic cam curve is generated such that a waveform of the cam velocity has a section where the cam velocity is the fixed cam velocity for each of regions, which are regions among designated coordinates, and has a monotonous acceleration or deceleration section that connects sections, where the cam velocity is the fixed cam velocity, by accelerating or decelerating while monotonously increasing or monotonously decreasing between adjacent regions.

In this case, it is considered what kinds of conditions the fixed cam velocities V₁, . . . , and V_{N} of the cam velocity need to satisfy to pass designated coordinates (Xᵢ, Yᵢ) (i=1, 2, . . . , and N) right in the middles of the acceleration or deceleration sections tᵢ.

An amount the driven shaft moves while the main shaft position moves from 0 to X₁ can be represented by a sum of amounts of movement A11 to A13 described below.

The amount of movement A11 of the driven shaft that moves when the main shaft position moves from 0 to t₀ (equivalent to (a) in FIG. 6)

The amount of movement A12 of the driven shaft that moves when the main shaft moves from t₀ to X₁−t₁/2 (equivalent to (b) in FIG. 6)

The amount of movement A13 of the driven shaft that moves when the main shaft position moves from Xₗ−t₁/2 to X₁ (equivalent to (c) in FIG. 6)

The amounts of movement A11, A12, and A13 of (a), (b), and (c) in FIG. 6 can be represented as shown below using a relation among Formulas (8) to (10). A11=(½)V₁t₀

A12=V₁(X₁−t₀−t₁/2)

A13=α₁(V₂−V₁)+V₁t₁/2

In the above, α1 is a value obtained by substituting t=t₁ in α of Formula (8). α₁ conforms to the definition of Formula (4). In the following explanation, it is assumed that α₁ and β₁ represent values obtained by substituting t=t₁ in α and β of Formulas (8) and (9). α₁ and β₁ conform to the definition of Formulas (4) and (5). A total of (a), (b), and (c) (an amount of movement A14) can be represented by Formula (11) below.

A14=(X₁−t₀/2−α₁)V₁+α₁V₂ (11)

To set an amount of movement of the driven shaft position to Y1 when the driven shaft position passes the coordinate (X₁, Y₁) (when the main shaft position moves from 0 to X₁), the amount of movement A14 of Formula (11) needs to be equal to Y₁. This is equal to an expression of a first row of Formula (6).

Similarly, an amount the driven shaft moves while the main shaft position moves from X₁ to X₂ can be represented by a total of amounts of movement A21 to A23 described below.

The amount of movement A21 of the driven shaft that moves when the main shaft position moves from X₁ to X₁+t₁/2 (equivalent to (d) in FIG. 6)

The amount of movement A22 of the driven shaft that moves when the main shaft position moves from X₁+t₁/2 to X₂−t₂/2 (equivalent to (e) in FIG. 6)

The amount of movement A23 of the driven shaft that moves when the main shaft position moves from X₂−t₂/2 to X₂ (equivalent to (f) in FIG. 6)

The amounts of movement A21, A22, and A23 of (d), (e), and (f) in FIG. 6 can be represented as shown below using the relation of Formulas (8) to (10).

A21=β₁(V₂−V₁)+V₁t₁/2

A22=V₂{X₂−X₁−(t₁/2)−(t₂/2)}

A23=β₂(V₂−V₂)+V₂t₂/2

A total of (d), (e), and (f) (an amount of movement A24) can be represented by Formula (12) below.

A24=(−β₁+t₁/2)V₁+(β₁+X₂−X₁−t₁/2−α₂)V₂+α₂V₃ (12)

To set the driven shaft position to Y₂ when the driven shaft position passes the coordinate (X₂, Y₂) (when the main shaft position moves from X₁ to X₂), the amount of movement A24 of Formula (12) needs to be equal to Y₂−Y₁. This is equal to an expression of a second row of Formula (6).

Similarly, concerning i of 2≦i≦N−1, an amount of movement of the driven shaft position is Y₁−Yᵢ₋₁ when the driven shaft position passes the coordinate (Xᵢ, Yᵢ) (when the main shaft position moves from Xᵢ₋₁ to Xᵢ). Therefore, a relation shown below needs to be satisfied.

(−βᵢ₋₁+tᵢ₋₁/2)Vᵢ₋₁+(βᵢ₋₁+Xᵢ−Xᵢ₋₁−tᵢ₋₁/2−αᵢ)Vᵢ+αᵢVᵢ₊₁=Yᵢ−Yᵢ₋₁

These are equal to an ith row (2≦i≦N−1) of Formula (6).

Further, an amount the driven shaft moves while the main shaft position moves from X_{N-1} to X_{N} can be represented by a total of amounts of movement An1 to An3 described below.

The amount of movement An1 of the driven shaft that moves when the main shaft position moves from X_{N-1} to t_{N-1}/2 (equivalent to (g) in FIG. 6)

The amount of movement An2 of the driven shaft that moves when the main shaft position moves from X_{N-1}+t_{N-1}/2 to X_{N}−t_{N} (equivalent to (h) in FIG. 6)

The amount of movement An3 of the driven shaft that moves when the main shaft position moves from X_{N}−t_{N} to X_{N} (equivalent to (i) in FIG. 6)

The amounts of movement An1, An2, and An3 of (g), (h), and (i) in FIG. 6 can be represented as shown below using the relation of Formulas (8) to (10).

An1=β_{N-1}(V_{N}−V_{N-1})+V_{N-1}t_{N-1}/2

An2=V_{N}(X_{N}−t_{N}−t_{N-1}/2)

An3=(½)V_{N}t_{N}

A total of (g), (h), and (i) (an amount of movement An4) can be represented by Formula (13) below.

An4=(−β_{N-1}+t_{N-1}/2)V_{N-1}+(β_{N1}+X_{N}−X_{N-1}−t_{N-1}/2−t_{N}/2)V_{N} (13)

To set an amount of movement of the driven shaft position to Y_{N}-Y_{N-1} when the driven shaft position passes the coordinate (X_{N}, Y_{N}) (when the main shaft position moves from X_{N-1} to X_{N}), An4 of Formula (13) needs to be equal to Y_{N} Y_{N-1}. This is represented by an Nth row of Formula (6).

Consequently, to pass all the designated coordinates (Xᵢ, Yᵢ) (i=1, 2, . . . , and N), the fixed cam velocities Vᵢ need to satisfy Formula (6). By solving Formula (6), when the fixed cam velocities V₁, . . . , and V_{N} are determined, a waveform of cam velocity that linearly connects the predetermined cam velocities Vᵢ, the cam velocities adjacent to the cam velocities Vᵢ on one side, and the cam velocities Vᵢ₊₁ adjacent to the cam velocities Vᵢ on the other side are sectionally determined. Therefore, an expression of cam velocity for the main shaft position X can be represented using the fixed cam velocities Vi, the designated coordinate data (Xᵢ, Yᵢ) (i=1, 2, . . . , and N), and the acceleration or deceleration sections tᵢ (i=0, 1, . . . , and N). Further, a relational expression (an electronic cam curve) with the driven shaft position with respect to an arbitrary main shaft position X can be calculated using Formulas (7-1) to (7-9) by integrating the cam velocity with respect to the main shaft position X.

In the example explained in this embodiment, the electronic cam curve is formed to pass the designated coordinate right in the middle point between the acceleration or deceleration sections. However, the electronic cam curve can be formed such that the designated coordinate (the cam velocity) passes an arbitrary halfway point (middle point) between the acceleration or deceleration sections. In this case, as in the embodiment, effects same as the effects explained above can be obtained.

As explained above, according to the first embodiment, the electronic cam curve is generated such that the cam curve is formed by the fixed velocity, the monotonous acceleration or deceleration that linearly accelerates or decelerates while monotonously increasing or monotonously decreasing with respect to the adjacent fixed velocity. Therefore, it is possible to suppress the acceleration of the driven shaft during driving while causing the driven shaft to pass a designated coordinate.

### Second Embodiment

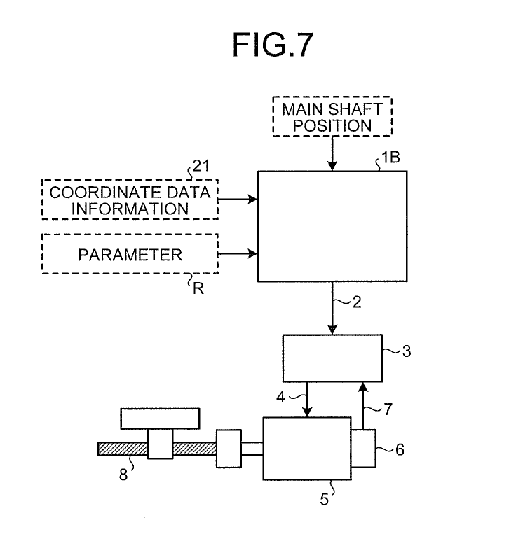

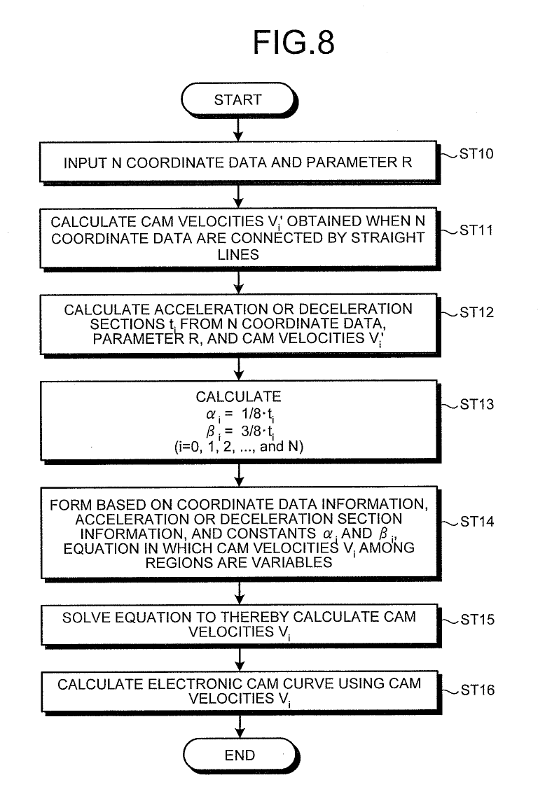

A second embodiment of the present invention is explained with reference to FIGS. 7 and 8. The electronic cam system according to the first embodiment obtains the electronic cam curve using the (N+1) acceleration or deceleration sections besides the designated N coordinates. An electronic cam system according to the second embodiment obtains an electronic cam curve having characteristics similar to the characteristics in the first embodiment. However, the electronic cam system uses one parameter instead of the (N+1) acceleration or deceleration sections. The electronic cam system automatically determines the (N+1) acceleration or deceleration sections and thereafter obtains the electronic cam curve.

FIG. 7 is a diagram of the configuration of the electronic cam system according to the second embodiment. Among components shown in FIG. 7, components that attain functions similar to the functions of the electronic cam system according to the first embodiment shown in FIG. 1 are denoted by the same reference numerals. Redundant explanation of the components is omitted.

The electronic cam system according to this embodiment includes an electronic cam control device 1B instead of the electronic cam control device 1A. Like the electronic cam control device 1A, the electronic cam control device 1B includes the information input unit 11, the electronic-cam-curve generating unit 12, the electronic-cam-curve storing unit 13, the main-shaft-position input unit 14, the driven-shaft-position-command generating unit 15, and the output unit 16.

The coordinate data information 21 and one parameter R are input to the information input unit 11 in this embodiment. The electronic-cam-curve generating unit 12 in this embodiment generates an electronic cam curve using the coordinate data information 21 and the one parameter R. The parameter R in this embodiment is a parameter for adjusting the magnitude of cam acceleration explained below.

FIG. 8 is a flowchart for explaining a procedure of processing for generating an electronic cam curve according to the second embodiment. The coordinate data information 21 (N coordinate data) and the one parameter R are input to the information input unit 11 of the electronic cam control device 1B (step ST10). A range of the parameter R is set as 0<R<1.

The electronic-cam-curve generating unit 12 calculates cam velocities Vᵢ′ (i=1, 2, . . . , and N) obtained when the N coordinate data input as designated coordinates are connected by only straight lines (step ST11). Specifically, the electronic-cam-curve generating unit 12 connects the N coordinate data using only the straight lines and calculates the cam velocities Vᵢ′ based on the coordinate data connected by the straight lines. At this point, the electronic-cam-curve generating unit 12 calculates the cam velocities Vᵢ′ using Formula (14) below. It is assumed that X₀=0 and Y₀=0.

$${V}_{i}^{′} = \frac{{Y}_{i} - {Y}_{i - 1}}{{X}_{i} - {X}_{i - 1}} \qquad ( 14 )$$

The electronic-cam-curve generating unit 12 calculates (N+1) acceleration or deceleration sections tᵢ using the parameter R, the N coordinate data, and the cam velocities Vᵢ′ (step ST12). Specifically, the electronic-cam-curve generating unit 12 calculates a variable G shown below using the calculated cam velocities Vᵢ′ and the coordinate data. The electronic-cam-curve generating unit 12 calculates the variable G using Formula (15) shown below. It is assumed that min[A₁, A₂, . . . , and A_{N}] represents a function that takes a smallest value among A₁, A₂, . . . , and A_{N}.

$$G = min [ \frac{{X}_{1}}{\vert {V}_{1}^{′} \vert + \frac{\vert {V}_{2}^{′} - {V}_{1}^{′} \vert}{2}} , \frac{{X}_{2} - {X}_{1}}{\frac{\vert {V}_{2}^{′} - {V}_{1}^{′} \vert}{2} + \frac{\vert {V}_{3}^{′} - {V}_{2}^{′} \vert}{2}} , … , \frac{{X}_{N - 1} - {X}_{N - 2}}{\frac{\vert {V}_{N - 1}^{′} - {V}_{N - 2}^{′} \vert}{2} + \frac{\vert {V}_{N}^{′} - {V}_{N - 1}^{′} \vert}{2}} , \frac{{X}_{N} - {X}_{N - 4}}{\frac{\vert {V}_{N}^{′} - {V}_{N - 1}^{′} \vert}{2} + \vert {V}_{N}^{′} \vert} ] \qquad ( 15 )$$

Further, the electronic-cam-curve generating unit 12 calculates acceleration or deceleration sections as indicated by Formula (16) below using the calculated variable G.

t₀=R×G×|V₁′|

tᵢ=R×G×|Vᵢ′−Vᵢ₋₁′|2≦i ≦N

t_{N}=R×G×|V_{N}′| (16)

Formula (16) is equivalent to setting the acceleration or deceleration sections to be proportional to absolute values of differences between the cam velocities Vᵢ′ and cam velocities Vᵢ₋₁′ of adjacent regions obtained when the designated coordinates are connected by the straight lines. Concerning t₀ and t_{N}, Formula (16) is equivalent to setting t₀ and t_{N} regarding adjacent cam velocities as 0. In other words, concerning t₀ and t_{N}, Formula (16) is equivalent to setting the acceleration or deceleration sections to be proportional to a difference value of a main shaft position between the designated coordinates.

Thereafter, the electronic-cam-curve generating unit 12 performs processing at steps ST13 to ST16. The processing at steps ST13 to ST16 is processing same as the processing at steps ST2 to ST5 explained with reference to FIG. 3 in the first embodiment. Therefore, explanation of the processing is omitted.

Effects of this embodiment are explained. The first embodiment and this embodiment are different only in whether the acceleration or deceleration sections are directly input or only the parameter R is input and the acceleration or deceleration sections are calculated from the parameter R. Therefore, this embodiment has effects same as the effects of the first embodiment. Effects not obtained in the first embodiment and obtained in the second embodiment are explained.

The cam velocity differentiated with respect to the main shaft position is referred to as cam acceleration. The cam acceleration is equivalent to a value obtained by multiplying the acceleration of a driven shaft with a constant when the main shaft position increase at a fixed rate. The cam acceleration is a factor for determining in which degree the acceleration of the driven shaft motor is.

In the first embodiment, the magnitude of the cam acceleration can be adjusted by changing the sizes of the acceleration or deceleration sections tᵢ. If the acceleration or deceleration sections tᵢ are increased in size, when a main shaft passes the acceleration or deceleration sections tᵢ, the acceleration of the driven shaft decreases. According to the decrease in the acceleration, the torque of the driven shaft motor also decreases.

In this embodiment, acceleration or deceleration sections for generally uniformalizing cam accelerations can be automatically calculated from the one parameter R. Further, the magnitudes of the cam accelerations can be adjusted by adjusting the magnitude of the parameter R. Specifically, the cam accelerations can be reduced by increasing the parameter R. Consequently, there is an effect that, when the driven shaft motor is driven according to the electronic cam curve, it is possible to easily prevent the driven shaft motor from being driven exceeding maximum torque.

An electronic cam curve for uniformalizing the cam accelerations irrespective of acceleration or deceleration sections can be generated by the calculation at steps ST10 and ST11 explained in the flowchart of FIG. 8. A reason for this is explained below.

In the first embodiment, as explained with reference to FIG. 3, the fixed cam velocities set in the adjacent regions are connected by the cam velocity having the linear wave form that monotonously increases or monotonously decreases. Because a part of sections of the cam velocities is formed by the fixed cam velocities Vᵢ, the electronic cam curve obtained in the first embodiment has a characteristic that the electronic cam curve is close to an electronic cam curve obtained by connecting coordinates using only straight lines. The cam velocities Vᵢ′ (i=1, 2, . . . , and N) of regions among designated coordinates obtained when the cam velocities are connected only by the straight lines as in this embodiment and the fixed cam velocities Vᵢ (i=1, 2, . . . , and N) in the first embodiment are values close to each other concerning i corresponding to the cam velocities Vᵢ′ and Vᵢ.

From the definition of the cam acceleration, absolute values of cam accelerations in the acceleration or deceleration sections are calculated by a value obtained by dividing an absolute value of a difference between adjacent velocities by the acceleration or deceleration sections. Therefore, in a cam curve in which cam accelerations are equal in the acceleration or deceleration sections (absolute values of the cam accelerations at this point are represented as “a”), Formula (17) shown below holds.

$$a = \frac{\vert {V}_{1} \vert}{{t}_{0}} = \frac{\vert {V}_{2} - {V}_{1} \vert}{{t}_{1}} = … = \frac{\vert {V}_{N} - {V}_{N - 1} \vert}{{t}_{N - 1}} = \frac{\vert {V}_{N} \vert}{{t}_{N}} \qquad ( 17 )$$

When Formula (17) is used, the acceleration or deceleration sections tᵢ (i=1, 2, . . . , N) can be represented by Formula (18) using “a” and Vᵢ (i=1, . . . , and N).

$${t}_{0} = \frac{\vert {V}_{1} \vert}{a} \\ {t}_{1} = \frac{\vert {V}_{2} - {V}_{1} \vert}{a} \\ ⋮ \\ {t}_{N - 1} = \frac{\vert {V}_{N} - {V}_{N - 1} \vert}{a} \\ {t}_{N} = \frac{\vert {V}_{N} \vert}{a} \qquad ( 18 )$$

When Formula (18) is substituted in Formulas (1), (2), and (3) representing the limitations on the coordinate data and the acceleration or deceleration sections, Formula (19) shown below can be obtained. Therefore, inverses of the cam accelerations need to satisfy all limitations indicated by Formula (20) below.

$$\begin{matrix}\frac{\vert {V}_{1} \vert}{a} + \frac{\vert {V}_{2} - {V}_{1} \vert / 2}{a} < {X}_{1} \\ \frac{\vert {V}_{i} - {V}_{i - 1} \vert / 2}{a} + \frac{\vert {V}_{i + 1} - {V}_{i} \vert / 2}{a} < {X}_{i} - {X}_{i - 1} \\ \frac{\vert {V}_{N} - {V}_{N - 1} \vert / 2}{a} + \frac{\vert {V}_{N} \vert}{a} < {X}_{N} - {X}_{N - 1} & ( 19 ) \\ \frac{1}{a} < \frac{{X}_{i}}{\vert {V}_{i} \vert + \frac{\vert {V}_{2} - {V}_{1} \vert}{2}} \\ \frac{1}{a} < \frac{{X}_{i} - {X}_{i - 1}}{\frac{\vert {V}_{i} - {V}_{i - 1} \vert}{a} + \frac{\vert {V}_{i + 1} - {V}_{i} \vert}{2}} ( i = 2 , 3 , … , N - 1 ) \\ \frac{1}{a} < \frac{{X}_{N} - {X}_{N - 1}}{\frac{\vert {V}_{N} - {V}_{N - 1} \vert}{2} + \vert {V}_{N} \vert} & ( 20 )\end{matrix}$$

Because Vᵢ and Vᵢ′ can be regarded as substantially equal as explained above, when Vᵢ=Vᵢ′ is substituted in Formula (20), Formula (21) below can be obtained.

$$\frac{1}{a} < \frac{{X}_{i}}{\vert {V}_{i}^{′} \vert + \frac{\vert {V}_{2}^{′} - {V}_{1}^{′} \vert}{2}} \\ \frac{1}{a} < \frac{{X}_{i} - {X}_{i - 1}}{\frac{\vert {V}_{i}^{′} - {V}_{i - 1}^{′} \vert}{a} + \frac{\vert {V}_{i + 1}^{′} - {V}_{i}^{′} \vert}{2}} ( i = 2 , 3 , … , N - 1 ) \\ \frac{1}{a} < \frac{{X}_{N} - {X}_{N - 1}}{\frac{\vert {V}_{N}^{′} - {V}_{N - 1}^{′} \vert}{2} + \vert {V}_{N}^{′} \vert} \qquad ( 21 )$$

Right sides of Formula (21) respectively correspond to arguments of the function min of Formula (15). Therefore, G is a value for uniformalizing absolute values of the cam accelerations in the acceleration or deceleration sections and can be regarded as an upper limit of the inverses of the cam accelerations that can be set. RxG obtained by multiplying the upper limit with the parameter R (0<R<1) is also a value for uniformalizing the absolute values of the cam accelerations and can be the inverses of the absolute values of the cam accelerations. A formula obtained by substituting Vᵢ=Vᵢ′ in Formula (18) and substituting 1/a=R×G as the inverses of the absolute values of the can accelerations is Formula (16).

For example, when R is increased, the acceleration or deceleration section increases from Formula (16). Therefore, the cam acceleration and the acceleration of the driven shaft motor decrease. The driving torque decreases according to the decrease in the cam acceleration and the acceleration of the driven shaft motor. On the other hand, when R is reduced, the acceleration or deceleration section decreases. Therefore, the cam acceleration and the acceleration of the driven shaft motor increase. The driving torque increases according to the increase in the cam acceleration and the acceleration of the driven shaft motor.

As explained above, according to the second embodiment, it is possible to automatically calculate acceleration or deceleration sections for generally uniformalizing cam accelerations from one parameter R. It is possible to adjust the magnitudes of the cam accelerations by adjusting the magnitude of the parameter R. Therefore, when the driven shaft motor is driven according to the electronic cam curve, it is possible to easily prevent the driven shaft motor from being driven exceeding the maximum torque.

### Third Embodiment

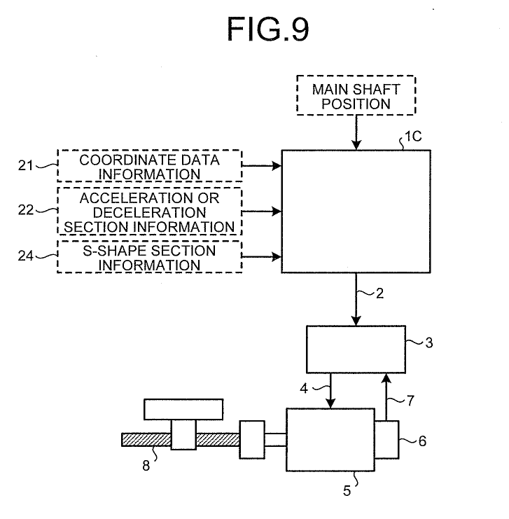

A third embodiment of the present invention is explained with reference to FIGS. 9 to 11. The electronic cam system according to the first and second embodiments generates the electronic cam curve having the waveform in which the cam velocity obtained by differentiating a driven shaft position with respect to a main shaft position linearly accelerates or decelerates between the fixed cam velocities Vᵢ and Vᵢ+1 of the adjacent regions. An electronic cam system according to the third embodiment generates an electronic cam curve to connect fixed cam velocities in adjacent regions while monotonously increasing or monotonously reducing the fixed cam velocities according to an arbitrary curve. In an example explained in this embodiment, the electronic cam curve is generated such that the fixed cam velocities in the adjacent regions are connected by a curve that continuously accelerates or decelerates. The electronic cam system according to this embodiment generates, for example, an electronic cam curve in which a cam velocity accelerates or decelerates to draw an S curve.

FIG. 9 is a diagram of the configuration of the electronic cam system according to the third embodiment. Among components shown in FIG. 9, components that attain functions same as the functions of the electronic cam system according to the first embodiment shown in FIG. 1 are denoted by the same reference numerals. Redundant explanation of the components is omitted.

The electronic cam system according to this embodiment includes an electronic cam control device 1C instead of the electronic cam control device 1A. Like the electronic cam control device 1A, the electronic cam control device 1C includes the information input unit 11, the electronic-cam-curve generating unit 12, the electronic-cam-curve storing unit 13, the main-shaft-position input unit 14, the driven-shaft-position-command generating unit 15, and the output unit 16.

The coordinate data information 21, the acceleration or deceleration section information 22, and S-shape section information 24 are input to the information input unit 11 in this embodiment. The electronic-cam-curve generating unit 12 in this embodiment generates an electronic cam curve using the coordinate data information 21, the acceleration or deceleration section information 22, and the S-shape section information 24. The S-shape section information 24 is information indicating a section where cam velocity draws an S curve. The S-shape section information 24 includes information indicating (N+1) S-shape sections.

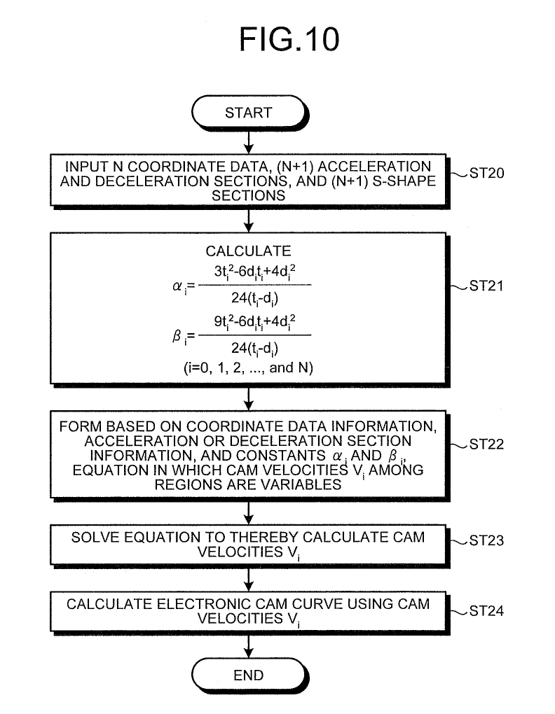

FIG. 10 is a flowchart for explaining a procedure of processing for generating an electronic cam curve according to the third embodiment. The coordinate data information 21, the acceleration or deceleration section information 22, and the S-shape section information 24 are input to the information input unit 11 of the electronic cam control device 1C (step ST20). Specifically, N coordinate data (X₁, Y₁), (X₂, Y₂), and (X_{N}, Y_{N}) for defining positions Yᵢ where a driven shaft should pass when a main shaft passes positions Xᵢ are input to the information input unit 11 as the coordinate data information 21. It is assumed that the data concerning a main shaft position have a relation 0<Xₗ<X₂<X₀< . . . <X_{N}. Reference coordinate data is represented as coordinate data (X₀, Y₀)=(0, 0).

(N+1) acceleration or deceleration sections t₀, t₁, t₂, . . . , and t_{N} representing section lengths required until cam velocity reaches fixed velocity are input as acceleration or deceleration section information 22. Further, (N+1) S-shape sections d₀, d₁, d₂, . . . , and d_{N} representing sections for smoothing acceleration and deceleration during the start and during the end in the acceleration or deceleration sections are input as the S-shape section information 24. It is assumed that a limitation of 0≦dᵢtᵢ/2 is applied to S-shape sections dᵢ (i=0, . . . , and N).

The electronic-cam-curve generating unit 12 calculates αᵢ and βᵢ according to Formulas (22) and (23) below using the acceleration or deceleration sections tᵢ and the S-shape sections dᵢ (step ST21).

$$\begin{matrix}{α}_{i} = \frac{3 {t}_{i}^{2} - 6 {d}_{i} {t}_{i} + 4 {d}_{i}^{2}}{24 ( {t}_{i} - {d}_{i} )} & ( 22 ) \\ {β}_{i} = \frac{9 {t}_{i}^{2} + 6 {d}_{i} {t}_{i} + 4 {d}_{i}^{2}}{24 ( {t}_{i} - {d}_{i} )} & ( 23 )\end{matrix}$$

Thereafter, the electronic-cam-curve generating unit 12 performs processing at steps ST22 and ST23. The processing at steps ST22 and ST23 is processing similar to the processing at step ST3 and ST4 explained with reference to FIG. 3 in the first embodiment.

Specifically, the electronic-cam-curve generating unit 12 forms, based on the coordinate data information 21, the acceleration or deceleration section information 22, and the constants αᵢ and βᵢ, simultaneous linear equations with N unknown variables of Formula (6) in which variables are the cam velocities Vᵢ (i=1, 2, . . . , and N) of coordinate sections (step ST22).

As explained in the first embodiment, Formula (6) represents an equation for defining that, with respect to the input coordinates (Xᵢ, Yᵢ) (i=1, 2, . . . , and N) and acceleration or deceleration sections tᵢ (i=0, 1, . . . , and N), designated coordinates pass coordinates (Xᵢ, Yᵢ) (i=1, 2, . . . , and N−1) right in middle points of the acceleration or deceleration sections tᵢ and pass (X_{N}, Y_{N}) at the end point of the acceleration or deceleration section t_{N}.

After forming the equation of Formula (6), the electronic-cam-curve generating unit 12 solves the simultaneous linear equations with N unknown variables of Formula (6) to thereby calculate the cam velocities Vᵢ (i=1, 2, . . . , and N) (step ST23).

The electronic-cam-curve generating unit 12 calculates, based on the calculated cam velocities Vᵢ, a driven shaft position Y(X) corresponding to a main shaft position X (step ST24) according to Formulas (24-1) to (24-16) below (step ST24).

$$\begin{matrix}0 \leq X \leq {d}_{0} \\ y ( X ) = \frac{{V}_{1}}{6 {t}_{0} ( {t}_{0} - {d}_{0} )} {X}^{3} & ( 24 \text{-} 1 ) \\ {d}_{0} < X < {t}_{0} - {d}_{0} \\ y ( X ) = \frac{{V}_{1}}{6 {t}_{0} ( {t}_{0} - {d}_{0} )} ( 3 {X}^{2} - 3 {d}_{0} X + {d}_{0}^{2} ) & ( 24 \text{-} 2 ) \\ {d}_{0} \leq X \leq {t}_{0} \\ y ( X ) = \frac{{V}_{1}}{6 {t}_{0} ( {t}_{0} - {d}_{0} )} \{ \begin{matrix}- {X}^{3} + 3 {t}_{0} {X}^{2} + \\ ( 6 {t}_{0} {d}_{0} - 6 {d}_{0}^{2} - 3 {t}_{0}^{2} ) X + \\ {t}_{0}^{3} - 3 {d}_{0} {t}_{0}^{2} + 3 {d}_{0}^{2} {t}_{0}\end{matrix} \} & ( 24 \text{-} 3 ) \\ {t}_{1} < X < {X}_{1} - {t}_{1} / 2 \\ y ( X ) = {V}_{1} X - \frac{1}{2} {V}_{1} {t}_{0} & ( 24 \text{-} 4 ) \\ {X}_{1} - {t}_{1} / 2 \leq X \leq {X}_{1} \\ y ( X ) = \frac{{V}_{2} - {V}_{1}}{6 {d}_{1} ( {t}_{1} - {d}_{1} )} {\{ X - ( {X}_{1} - \frac{{t}_{1}}{2} ) \}}^{3} + {V}_{1} X - \frac{1}{2} {V}_{1} {t}_{0} & ( 24 \text{-} 5 )\end{matrix}$$

With respect to 2≦i≦n,

$$\begin{matrix} 2 ≦ i ≦ N \\ {X}_{i - 1} \leq X \leq {X}_{i - 1} + {t}_{i - 1} / 2 - {d}_{i - 1} \\ ξ = X - {X}_{i - 1} + {t}_{i - 1} / 2 \\ y ( X ) = {Y}_{i - 1} - ( {α}_{i - 1} + {V}_{i - 1} {t}_{i - 1} / 2 ) + \frac{{V}_{i} - {V}_{i - 1}}{6 ( {t}_{i - 1} - {d}_{i - 1} )} \cdot ( 3 {ξ}^{2} - 3 {d}_{i - 1} ξ + {d}_{i - 1}^{2} ) & ( 24 \text{-} 6 ) \\ {X}_{i - 1} + {t}_{i - 1} / 2 - {d}_{i - 1} \leq X \leq {X}_{i - 1} + {t}_{i - 1} / 2 \\ ξ = X - {X}_{i - 1} + {t}_{i - 1} / 2 \\ y ( X ) = {Y}_{i - 1} - ( {α}_{i - 1} + {V}_{i - 1} {t}_{i - 1} / 2 ) + \frac{{V}_{i} - {V}_{i - 1}}{6 {d}_{i - 1} ( {t}_{i - 1} - {d}_{i - 1} )} \cdot \{ \begin{matrix}- {ξ}^{3} + 3 {t}_{i - 1} {ξ}^{2} + \\ ( 6 {t}_{i - 1} {d}_{i - 1} - 6 {d}_{i - 1}^{2} - 3 {t}_{i - 1}^{2} ) ξ + \\ {t}_{i - 1}^{3} - 3 {d}_{i - 1} {t}_{i - 1}^{2} + 3 {d}_{i - 1}^{2} {t}_{i - 1}\end{matrix} \} & ( 24 \text{-} 7 ) \\ {X}_{i - 1} + {t}_{i - 1} / 2 < X < {X}_{i} - {t}_{i} / 2 \\ y ( X ) = {Y}_{i - 1} + {β}_{i - 1} ( {V}_{i} - {V}_{i - 1} ) + {V}_{i - 1} {t}_{i - 1} / 2 + {V}_{i} ( X - {X}_{i - 1} - {t}_{i - 1} / 2 ) & ( 24 \text{-} 8 ) \\ {X}_{i - 1} - {t}_{i} / 2 \leq X \leq {X}_{i} - {t}_{i} / 2 + {d}_{i} \\ ξ = X - {X}_{i} + {t}_{i} / 2 \\ y ( X ) = {Y}_{i} - ( {α}_{i} + {V}_{i} {t}_{i} / 2 ) + \frac{{V}_{i + 1} - {V}_{i}}{6 {d}_{i} ( {t}_{i} - {d}_{i} )} \cdot {ξ}^{3} & ( 24 \text{-} 9 ) \\ {X}_{i} - {t}_{i} / 2 + {d}_{i} \leq X \leq {X}_{i} \\ ξ = X - {X}_{i} + {t}_{i} / 2 \\ y ( X ) = {Y}_{i} - ( {α}_{i} + {V}_{i} {t}_{i} / 2 ) + \frac{{V}_{i + 1} - {V}_{i}}{6 ( {t}_{i} - {d}_{i} )} \cdot ( 3 {ξ}^{2} - 3 {d}_{i} ξ + {d}_{i}^{2} ) & ( 24 \text{-} 10 ) \\ {X}_{N - 1} \leq X \leq {X}_{N - 1} + {t}_{N - 1} / 2 - {d}_{N - 1} \\ ξ = X - {X}_{N - 1} + {t}_{N - 1} / 2 \\ y ( X ) = {Y}_{N - 1} - ( {α}_{N - 1} + {V}_{N - 1} {t}_{N - 1} / 2 ) + \frac{{V}_{N} - {V}_{N - 1}}{6 ( {t}_{N - 1} - {d}_{N - 1} )} \cdot ( 3 {ξ}^{2} - 3 {d}_{N - 1} ξ + {d}_{N - 1}^{2} ) & ( 24 \text{-} 11 ) \\ {X}_{N - 1} + {t}_{N - 1} / 2 - {d}_{N - 1} \leq X \leq {X}_{N - 1} + {t}_{N - 1} / 2 \\ ξ = X - {X}_{N - 1} + {t}_{N - 1} / 2 \\ y ( X ) = {Y}_{N - 1} - ( {α}_{N - 1} + {V}_{N - 1} {t}_{N - 1} / 2 ) + \frac{{V}_{N} - {V}_{N - 1}}{6 {d}_{N - 1} ( {t}_{N - 1} - {d}_{N - 1} )} \cdot \{ \begin{matrix}- {ξ}^{3} + 3 {t}_{N - 1} {ξ}^{2} + \\ ( 6 {t}_{N - 1} {d}_{N - 1} - 6 {d}_{N - 1}^{2} - 3 {t}_{N - 1}^{2} ) ξ + \\ {t}_{N - 1}^{3} - 3 {d}_{N - 1} {t}_{N - 1}^{2} + 3 {d}_{N - 1}^{2} {t}_{N - 1}\end{matrix} \} & ( 24 \text{-} 12 ) \\ {X}_{N - 1} + {t}_{N - 1} / 2 < X < {X}_{N} - {t}_{N} \\ y ( X ) = {Y}_{N - 1} + {β}_{N - 1} ( {V}_{N} - {V}_{N - 1} ) + {V}_{N - 1} {t}_{N - 1} / 2 + {V}_{N} ( X - {X}_{N - 1} - {t}_{N - 1} / 2 ) & ( 24 \text{-} 13 ) \\ {X}_{N} - {t}_{N} \leq X \leq {X}_{N} - {t}_{N} + {d}_{N} \\ ξ = X - {X}_{N} + {t}_{N} \\ y ( X ) = {Y}_{N} - {V}_{N} {t}_{N} / 2 + {V}_{N} ξ - \frac{{V}_{N}}{6 {d}_{N} ( {t}_{N} - {d}_{N} )} {ξ}^{3} & ( 24 \text{-} 14 ) \\ {X}_{N} - {t}_{N} + {d}_{N} \leq X \leq {X}_{N} - {d}_{N} \\ ξ = X - {X}_{N} + {t}_{N} \\ y ( X ) = {Y}_{N} - {V}_{N} {t}_{N} / 2 + {V}_{N} ξ - \frac{{V}_{N}}{6 ( {t}_{N} - {d}_{N} )} \cdot ( 3 {ξ}^{2} - 3 {d}_{N} ξ + {d}_{N}^{2} ) & ( 24 \text{-} 15 ) \\ {X}_{N} - {t}_{N} \leq X \leq {X}_{N} \\ ξ = X - {X}_{N} + {t}_{N} \\ y ( X ) = {Y}_{N} - {V}_{N} {t}_{N} / 2 + {V}_{N} ξ - \frac{{V}_{N}}{6 {d}_{N} ( {t}_{N} - {d}_{N} )} \cdot \{ \begin{matrix}- {ξ}^{3} + 3 {t}_{N} {ξ}^{2} + \\ ( 6 {t}_{N} {d}_{N} - 6 {d}_{N}^{2} - 3 {t}_{N}^{2} ) ξ + \\ {t}_{N}^{3} - 3 {d}_{N} {T}_{N}^{2} + 3 {d}_{N}^{2} {T}_{N}\end{matrix} \} & ( 24 \text{-} 16 )\end{matrix}$$

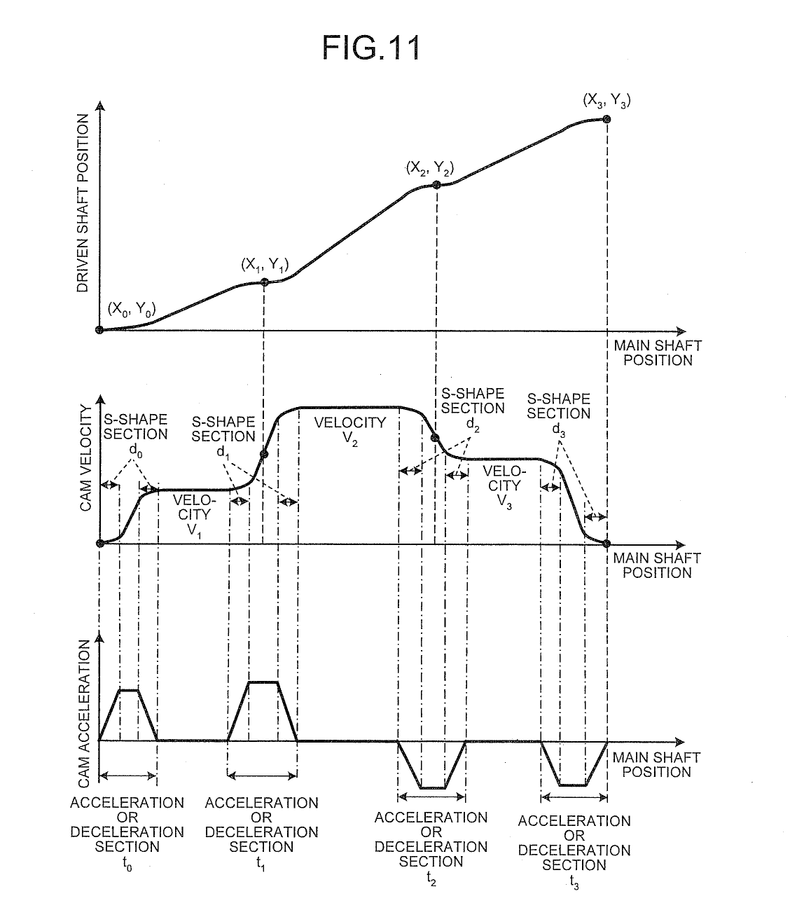

Effects of this embodiment are explained. FIG. 11 is a diagram of the electronic cam curve according to the third embodiment. In FIG. 11, a relation among the electronic cam curve (an upper waveform), a relation among the electronic cam curve (an upper waveform) generated according to the flowchart of FIG. 10, a schematic shape of cam velocity (a middle waveform) obtained by differentiating the electronic cam curve with respect to the main shaft position, and a schematic shape of cam acceleration (a lower waveform) obtained by differentiating the cam velocity with respect to the main shaft position is shown.

In a graph shown on the upper side of FIG. 11, the abscissa indicates the main shaft position and the ordinate indicates the driven shaft position. A waveform passing the coordinates (X₀, Y₀) to (X₃, Y₃) is the electronic cam curve. In a graph shown in the middle of FIG. 11, the abscissa indicates the main shaft position and the ordinate indicates the cam velocity. In a graph shown on the lower side of FIG. 11, the abscissa indicates the main shaft position and the ordinate indicates the cam acceleration.

The can velocity in this embodiment includes the fixed cam velocities Vᵢ, monotonous acceleration or deceleration that monotonously increases or monotonously decreases with respect to adjacent fixed cam velocities, and S-shape change velocity for performing acceleration or deceleration to draw an S curve with respect to an increase in the main shaft position. In other words, the waveform of the cam velocity includes, for each of regions, which are regions among designated coordinates, a section of a fixed cam velocity, a monotonous acceleration or deceleration section, and the S-shape change velocity. The monotonous acceleration or deceleration section is arranged between sections where the cam velocity accelerates or decelerates while monotonously increasing or monotonously decreasing and is the fixed cam velocity between adjacent regions. The S-shape change velocity accelerates or decelerates to draw an S curve with respect to an increase in the main shaft position. The S-shape change velocity is arranged to connect the section of the fixed cam velocity and the monotonous acceleration or deceleration section.

The electronic cam curve is generated such that the lengths of acceleration or deceleration sections are tᵢ (i=1, 2, . . . , and N) and to pass designated coordinates (Xᵢ, Yᵢ) (i=1, 2, . . . , and N−1) in the middles of the sections and pass (X_{N}, Y_{N}) at the end of acceleration.

In the electronic cam curve according to this embodiment, the S-shape sections dᵢ are provided at the starts and the ends of the acceleration or deceleration sections tᵢ (ends of the sections). In the S-shape sections, acceleration and deceleration is gentle. The waveform of the cam acceleration in the first and second embodiment in which there is no S-shape section is rectangular. On the other hand, in this embodiment, because the S-shape sections are provided in the cam velocity, the waveform of the cam acceleration of the electronic cam curve is a trapezoidal waveform between the acceleration or deceleration sections.

In this embodiment, the fixed cam velocities Vᵢ and Vᵢ₊₁ are connected to monotonously increase or monotonously decrease in an S shape. Therefore, this embodiment has effects similar to the effects of the first embodiment. In this embodiment, the cam velocity is accelerated and decorated such that the waveform of the cam velocity draws an S curve rather than a straight line. Therefore, there is an effect that acceleration and torque required for driving are smoothed and a shock of a machine driven by the driven shaft motor is further reduced.

Formulas (24-1) to (24-16) used in this embodiment are derived by a procedure similar to the procedure in the first embodiment. Specifically, a formula representing overall cam velocity is calculated from input coordinate data, the acceleration or deceleration sections, the S-shape sections, and the fixed cam velocities Vᵢ calculated from Formula (6). The electronic cam curve is obtained by integrating once the formula representing the overall cam velocity.

In the example explained in this embodiment, the acceleration or deceleration sections tᵢ are directly input. However, as explained in the second embodiment, it is also possible to input the parameter R and automatically determine acceleration or deceleration sections using the parameter R. In this case, the S-shape sections dᵢ can be set at a ratio corresponding to the sizes of the acceleration or deceleration sections tᵢ. In other words, it is also possible to input a parameter r (0≦r≦1), which is information for designating S-shape sections, and set the S-shape sections as dᵢ=r/2×tᵢ (i=1, 2, . . . , and N). Consequently, it is possible to automatically calculate acceleration or deceleration sections for generally uniformalizing cam velocity and obtain a cam curve in which the cam velocity is smooth.

As explained above, according to the third embodiment, the cam velocity is accelerated or decelerated such that the waveform of the cam velocity draws the S curve at the ends of the acceleration or deceleration sections. Therefore, acceleration and torque required for driving are smoothed. It is possible to reduce a shock of a machine driven by the driven shaft motor.

### Fourth Embodiment

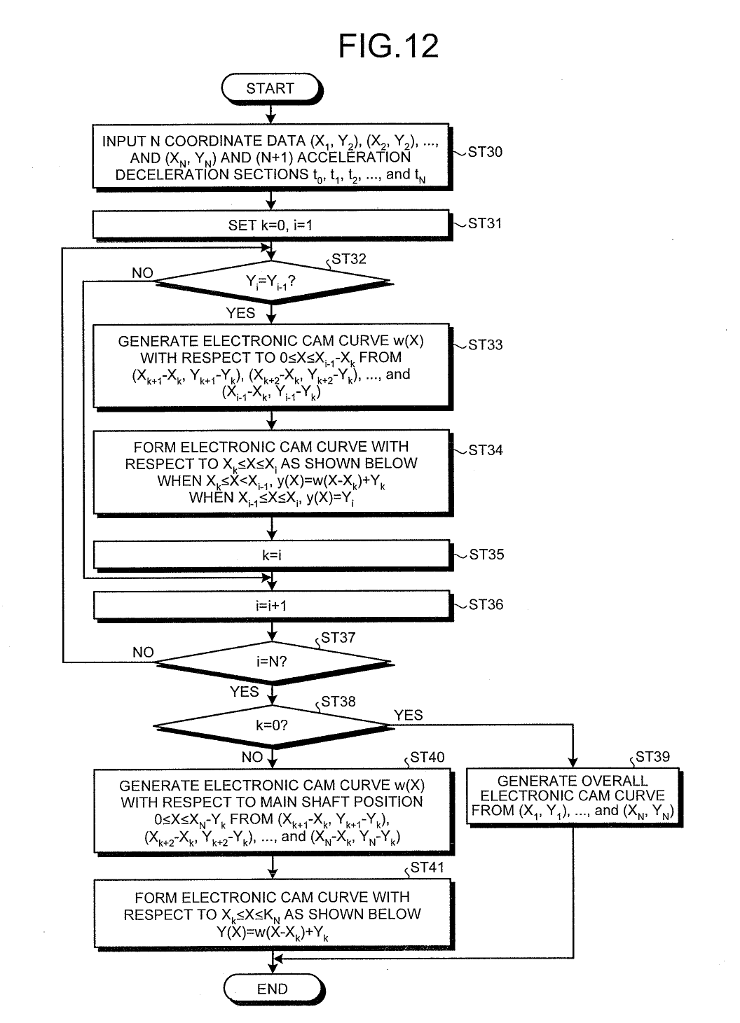

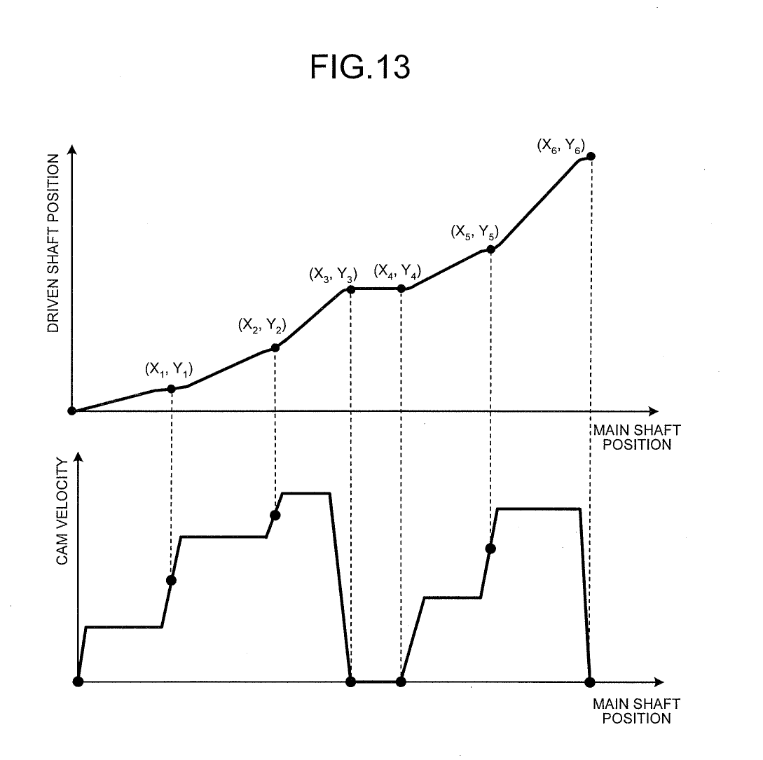

A fourth embodiment of the present invention is explained with reference to FIGS. 12 and 13. When driven shaft positions of adjacent designated coordinates are the same, an electronic cam system according to the fourth embodiment divides coordinate data before and after the designated coordinates. In other words, when the driven shaft positions of the adjacent designated coordinates are the same, the electronic-cam-curve generating unit 12 divides a coordinate region for defining an electronic cam curve before and after the adjacent designated coordinates.

The electronic-cam-curve generating unit 12 generates electronic cam curves with respect to the divided coordinate data. At this point, with respect to a region where the driven shaft positions of the adjacent designated coordinates are the same, the electronic-cam-curve generating unit 12 generates electronic cam curves in which the driven shaft positions are the same value. Further, the electronic-cam-curve generating unit 12 generates an electronic cam curve with respect to all the coordinate data by connecting the generated electronic cam curves. Consequently, the electronic cam system according to the fourth embodiment generates an electronic cam curve in which the driven shaft position can be stopped.

The electronic cam system according to this embodiment has components similar to the components of the electronic cam systems according to the first to third embodiments. Therefore, explanation of the components is omitted. In the following explanation, a generation processing procedure in which the electronic cam control device 1A generates an electronic cam curve according to this embodiment is explained.

FIG. 12 is a flowchart for explaining a procedure of processing for generating an electronic cam curve according to the fourth embodiment. The coordinate data information 21 and the acceleration or deceleration section information 22 are input to the information input unit 11 of the electronic cam control device 1A (step ST30). Specifically, N coordinate data and (N+1) acceleration or deceleration sections are input to the information input unit 11.

The parameter R explained in the second embodiment can be input instead of the (N+1) acceleration or deceleration section information 22. The (N+1) S-shape section information 24 explained in the third embodiment can be input in addition to the coordinate data information 21 and the acceleration or deceleration section information 22. The parameter r for determining S-shape sections can be input as S-shape section information.

The electronic-cam-curve generating unit 12 performs initialization of a variable k and a variable i necessary for calculation processing. Specifically, the electronic-cam-curve generating unit 12 sets the variable k to 0 and sets the variable i to 1 (step ST31).

The electronic-cam-curve generating unit 12 checks whether coordinate data Yᵢ representing a driven shaft position is equal to adjacent coordinate data Yᵢ₋₁. In other words, the electronic-cam-curve generating unit 12 determines whether Yᵢ=Yᵢ₋₁ holds (step ST32). If adjacent driven shaft positions of the input coordinate data are equal (Yes at step ST32), the electronic-cam-curve generating unit 12 calculates an electronic cam curve w(X), which is a part of the electronic cam curve (step ST33). A driven shaft position corresponding to the main shaft position X is represented by w(X).

Specifically, the electronic-cam-curve generating unit 12 calculates the electronic cam curve w(X) using coordinate data (Xₖ₊₁−Xₖ, Yₖ₊₁−Yₖ), (Xₖ₊₂−Xₖ, Yₖ₊₂−Yₖ), . . . , and (Xᵢ₋₁−Xₖ, Yᵢ₋₁−Yₖ) and acceleration or deceleration sections tₖ, tₖ₊₁, . . . , and tᵢ₋₁ such that the electronic cam curve w(X) passes the coordinate data (Xₖ₊₁−Xₖ, Yₖ₊₁−Yₖ), (Xₖ₊₂−Xₖ, Yₖ₊₂−Yₖ), . . . , and (Xᵢ₋₁−Xₖ, Yᵢ₋₁−Yₖ). At this point, the electronic-cam-curve generating unit 12 calculates the electronic cam curve w(X) according to the processing at steps ST2 to ST5 and the like explained in the first embodiment.

In this embodiment, the electronic-cam-curve generating unit 12 calculates the electronic cam curve w(X) using data obtained by subtracting (Xₖ, Yₖ) respectively from the coordinate data (Xₖ, Yₖ) to (Xᵢ₋₁, Yᵢ₋₁). This is equivalent to calculating the electronic cam curve with reference to the coordinate data (Xₖ, Yₖ), in which adjacent driven shaft positions are equal, in this embodiment, whereas the electronic cam curve is calculated with reference to (0, 0) in the first to third embodiments. Because the electronic cam curve w(X) passes (Xᵢ₋₁−Xₖ, Yᵢ₋₁−Yₖ), Formula (25) below holds.

w(Xᵢ₋₁−Xₖ)=Yᵢ₋₁−Yₖ (25)

The electronic-cam-curve generating unit 12 calculates, according to Formula (26) below, a portion corresponding to a main shaft position Xₖ≦X≦Xᵢ in the electronic cam curve Y(X) that passes N coordinate data (step ST34).

Xₖ≦X≦Xᵢ₋₁ [symbol] y(X)=w(X−Xₖ)+Yₖ

Xᵢ₋₁<X≦Xᵢ [symbol] y(X)=Yᵢ (26)

The electronic-cam-curve generating unit 12 calculates the electronic cam curve by adding the reference coordinate data (Xₖ, Yₖ) subtracted at step ST33 to the electronic cam curve w(X).

Thereafter, the electronic-cam-curve generating unit 12 substitutes i in the variable k (step ST35). The electronic-cam-curve generating unit 12 increases the variable i by +1 (i=i+1) (step ST36).

On the other hand, if Yᵢ=Yᵢ−1 does not hold (No at step ST32), the electronic-cam-curve generating unit 12 increases the variable i by +1 (i=i+1) without calculating the electronic cam curve w(X) (step ST36).

After increasing the variable i by +1 (i=i+1), the electronic-cam-curve generating unit 12 determines whether the variable i is equal to N (step ST37). If the variable i is not equal to N (if i<N) (No at step ST37), the electronic-cam-curve generating unit 12 executes the processing at steps ST32 to ST36 again.

On the other hand, if the variable i is equal to N (Yes at step ST37), the electronic-cam-curve generating unit 12 determines whether the variable k is equal to 0 (step ST38). When k=0 holds, this represents that coordinates of adjacent driven shaft positions are not equal at all in the processing at step ST32. When k=0 hold (Yes at step ST38), the electronic-cam-curve generating unit 12 generates an overall electronic cam curve from all the coordinate data (X₁, Y₁), . . . , and (X_{N}, Y_{N}) (step ST39). Specifically, the electronic-cam-curve generating unit 12 generates the overall electronic cam curve as explained in the first to third embodiments.

On the other hand, when k=0 does not hold (No at step ST38), the electronic-cam-curve generating unit 12 shifts to step ST40. At step ST40, the electronic-cam-curve generating unit 12 generates the electronic cam curve w(X) with respect to the main shaft position 0≦X≦X_{N}−Y_{N} from (Xₖ₊₁−Xₖ, Yₖ₊₁−Yₖ), (Xₖ₊₂−Xₖ, Yₖ₊₂−Yₖ), . . . , and (X_{N}−Xₖ, Y_{N}−Yₖ).

Thereafter, at step ST41, the electronic-cam-curve generating unit 12 forms an electronic cam curve with respect to Xₖ≦X≦K_{N} as y=w(X−Xₖ)+Yₖ using the electronic cam curve calculated at step ST39. The processing for generating the electronic cam curve ends.

Effects of this embodiment are explained. FIG. 13 is a diagram of the electronic cam curve according to the fourth embodiment. In FIG. 13, a relation between the electronic cam curve (an upper waveform) generated according to the flowchart of FIG. 12 and a schematic shape of cam velocity (a lower waveform) obtained by differentiating the electronic cam curve with respect to the main shaft position is shown.

In FIG. 13, it is assumed that Y₃=Y₄ concerning a driven shaft position in input coordinate data. According to the flowchart of FIG. 12, one electronic cam curve is formed by (X₁, Y₁), (X₂, Y₂), and (X₃, Y₃) at steps ST33 and ST34. Another electronic cam curve is formed by (X₄, Y₄), (X₅, Y₅), and (X₆, Y₆) at steps ST40 and ST41. With respect to X₃≦X≦X₄ between coordinates in which driven shaft positions are equal, another electronic cam curve in which the driven shaft position always takes Y₃=Y₄ is formed in the case of Xᵢ₋₁≦X≦Xᵢ at step ST34. As an overall electronic cam curve, an electronic cam curve obtained by combining all the electronic cam curves is calculated. When the electronic cam curve is formed as explained above, if the main shaft position X is X₃≦X≦X₄, even if the main shaft position X moves in the range, it is possible to obtain an electronic cam curve in which the driven shaft position does not change.

In other words, data in which driven shaft positions of adjacent designated coordinates are equal is input, whereby it is possible to obtain an electronic cam curve in which the driven shaft position can be stopped when the main shaft position is present between designated coordinates (in FIG. 12, X₃≦X≦X₄). Therefore, it is possible to easily obtain an electronic cam curve in which a section where the driven shaft position is stopped is designated.

As explained above, according to the fourth embodiment, in addition to the effects of the first to third embodiments, when the coordinate data Yi, Yi−1 representing the driven shaft position are equal, the coordinate data are divided before and after the coordinate data and the electronic cam curves are generated with respect to the divided coordinate data and combined. Therefore, it is possible to obtain an electronic cam curve in which the driven shaft position can be stopped.

Effects of the electronic cam curve having such characteristics are typically displayed in an application example explained below. It is conceivable to apply the electronic cam control to a liquid filling machine including a driving shaft that moves a conveying unit to thereby convey bottles arranged at a fixed interval to right under a nozzle and a driving shaft that drives an action for pushing down the nozzle to the bottle placed right under the nozzle and pushing up the nozzle after liquid is injected into the bottle, the liquid filling machine injecting the liquid into a large number of bottles in order using one nozzle.

The action of the driving shaft for controlling the up down movement of the nozzle needs to be synchronized with the action of the driving shaft for controlling the conveying unit. Therefore, the electronic cam control is performed using, as a main shaft, the driving shaft that controls the conveying unit and using, as a driven shaft, the shaft that controls the up down movement of the nozzle. When the electronic cam control is performed, the liquid spills if the nozzle is pushed down before the bottom moves to right under the nozzle. Therefore, it is desired that the shaft that moves up and down the muzzle maintains a stopped state until the shaft that controls the conveying unit moves from a position immediately before a position right under the bottle to the position right under the bottle.

When the electronic cam control device according to this embodiment is used, if the position immediately before the position right under the bottle is set as Xᵢ₋₁, the position right under the bottle is set as Xᵢ, and a position to which the nozzle is pushed up straight is set as Yᵢ=Yᵢ₋₁, the driven shaft can maintain the stopped state while the main shaft position is in a certain range (i.e., a range from the position immediately before the position right under the bottle to the position right under the bottle). Therefore, there is an effect that it is possible to realize a filling action without spilling the liquid.

### INDUSTRIAL APPLICABILITY

As explained above, the electronic cam control device and the electronic cam curve generating method according to the present invention are suitable for generation of an electronic cam curve in which acceleration of the driven shaft is suppressed.

### REFERENCE SIGNS LIST

1A to 1C electronic cam control devices
2 driven shaft position command
3 servo amplifier
5 servomotor
8 load machine
11 information input unit
12 electronic-cam-curve generating unit
13 electronic-cam-curve storing unit
14 main-shaft-position input unit
15 driven-shaft-position-command generating unit
16 output unit
21 coordinate data information
22 acceleration or deceleration section information
24 S-shape section information
R parameter

1. An electronic cam control device comprising:
an input unit configured to receive an input of a plurality of designated coordinates that define a relation between a main shaft position and a driven shaft position;
an electronic-cam-curve generating unit configured to generate an electronic cam curve to pass the plurality of designated coordinates, the electronic cam curve representing, as a curve, a relation between the main shaft position and the driven shaft position; and
an output unit configured to output the driven shaft position corresponding to the main shaft position as a driven shaft position command to an external device, the driven shaft position command confirming to the electronic cam curve, wherein
the electronic-cam-curve generating unit generates the electronic cam curve to include a section where a waveform of cam velocity obtained by differentiating the electronic cam curve with respect to the main shaft position changes to fixed cam velocity in each of regions, which are regions among the designated coordinates, and include a monotonous acceleration or deceleration section that connects sections where the waveform of the cam velocity changes to the fixed cam velocity by accelerating or decelerating while monotonously increasing or monotonously decreasing between adjacent regions.

2. The electronic cam control device according to claim 1, wherein
the electronic-cam-curve generating unit generates the electronic cam curve such that the waveform of the cam velocity linearly accelerates or decelerates in the monotonous acceleration or deceleration section.

3. The electronic cam control device according to claim 1, wherein
information for designating section length of the monotonous acceleration or deceleration section is further input to the input unit, and
the electronic-cam-curve generating unit generates, based on the plurality of designated coordinates and the section length of the monotonous acceleration or deceleration section, the electronic cam curve such that the cam velocity in the designated coordinates passes an arbitrary halfway point of the monotonous acceleration or deceleration section.

4. The electronic cam control device according to claim 3, wherein
the electronic-cam-curve generating unit forms, using coordinate data and information concerning acceleration or deceleration sections, an equation that represents that the designated coordinates pass the coordinate data and in which the fixed cam velocity is an unknown number and solves the equation to thereby calculate the fixed cam velocity.

5. The electronic cam control device according to claim 1, wherein
the electronic-cam-curve generating unit generates the electronic cam curve such that the waveform of the cam velocity accelerates or decelerates in an S shape in the monotonous acceleration or deceleration section.

6. The electronic cam control device according to claim 5, wherein
information for designating section length of the monotonous acceleration or deceleration section and section length of the S-shape section where the waveform of the cam velocity accelerates or decelerates in the S shape is further input to the input unit, and
the electronic-cam-curve generating unit generates, based on the plurality of designated coordinates, the section length of the monotonous acceleration or deceleration section, and the section length of the S-shape section, the electronic cam curve such that the cam velocity in the designated coordinates passes an arbitrary halfway point of the monotonous acceleration or deceleration section.

7. The electronic cam control device according to claim 6, wherein
the electronic-cam-curve generating unit forms, using coordinate data, information concerning acceleration or deceleration sections, and the information concerning the S-shape section, an equation that represents that the designated coordinates pass the coordinate data and in which the fixed cam velocity is an unknown number and solves the equation to thereby calculate the fixed cam velocity.

8. The electronic cam control device according to claim 1, wherein
the electronic-cam-curve generating unit generates the electronic cam curve such that magnitude of cam acceleration obtained by differentiating the cam velocity with respect to the main shaft position is uniform in the monotonous acceleration or deceleration section.

9. The electronic cam control device according to claim 8, wherein
the electronic-cam-curve generating unit sets the monotonous acceleration or deceleration section to be proportional to an absolute value of a difference between cam velocity obtained when first designated coordinates are connected by a straight line and cam velocity obtained when second designated coordinates adjacent to the first designated coordinates are connected by a straight line.

10. The electronic cam control device according to claim 1, wherein
the electronic-cam-curve generating unit generates the electronic cam curve to set the cam velocity to 0 in a first designated coordinate and a last designated coordinate.

11. The electronic cam control device according to claim 1, wherein,
when driven shaft positions of adjacent designated coordinates are the same, the electronic-cam-curve generating unit divides coordinate regions for defining the electronic cam curve before and after the designated coordinates, generates electronic cam curves respectively with respect to the divided coordinate regions, generates, with respect to coordinate regions where driven shaft positions of adjacent designated coordinate are the same, electronic cam in which driven shaft positions have the same value, and connects the electronic cam curves generated with respect to the coordinate regions to thereby generate an electronic cam curve with respect to all coordinate data.

12. An electronic cam curve generating method comprising:
an input step of inputting a plurality of designated coordinates that define a relation between a main shaft position and a driven shaft position; and
an electronic-cam-curve generating step of generating an electronic cam curve to pass the plurality of designated coordinates, the electronic cam curve representing, as a curve, a relation between the main shaft position and the driven shaft position, wherein
in generating the electronic curve, the electronic cam curve is generated to include a section where a waveform of cam velocity obtained by differentiating the electronic cam curve with respect to the main shaft position changes to fixed cam velocity in each of regions, which are regions among the designated coordinates, and include a monotonous acceleration or deceleration section that connects sections where the waveform of the cam velocity changes to the fixed cam velocity by accelerating or decelerating while monotonously increasing or monotonously decreasing between adjacent regions.
